(19) United States
(12) Patent Application Publication
(10) Pub. No.: US 2008/0315713 A1
(43) Pub. Date: Dec. 25, 2008

(54) Group of Laminations For Ferromagnetic Cores, Production Process and Respective Electric Machine

(75) Inventor: Monica Galvanin, Torri di Quartesolo (IT)

Correspondence Address: CONNOLLY BOVE LODGE & HUTZ LLP, 1875 EYE STREET, N.W., SUITE 1100, WASHINGTON, DC, 20006, US

(73) Assignee: GALVANIN LUIGINO S.P.A., TORRI DI QUARTESOLO (IT)

(21) Appl. No.: 11/915,403

(22) PCT Filed: May 23, 2006
(86) PCT No.: PCT/IB06/01414

§ 371 Date: Jun. 20, 2008

(30) Foreign Application Priority Data
May 26, 2005 (IT) VI2005A000159

(51) Int. Cl. H02K 1/12; H02K 15/02

(52) U.S. Cl. 310/254; 29/596

(57) ABSTRACT

The invention concerns a group of laminations (100), advantageously but not exclusively for making a ferromagnetic core, which comprises two or more laminations, one or more polar expansions (P1, P2, P3, P4) and a connecting element (5, 5a, 5b, 5c) belonging to one of the laminations (4, 4a, 4b, 4c, 6, 6a, 6b, 6c) having one end (7, 7c) suitably folded and counteracting another of the laminations to keep the laminations together. The invention also concerns a process and a die for making said group, as well as a respective electric machine.

The invention concerns a group of laminations and a process for manufacturing such a group, particularly suited to be employed for making ferromagnetic cores used in electric machines and/or devices, as well as a respective electric machine. As is known, electric motors and actuators have electromagnetic components, composed of a ferromagnetic core around which one or more coils of an electric conductor are wound.

Such ferromagnetic cores, which may be both fixed and mobile parts of the device, have the function of conveying the magnetic flux.

In particular, in the case of electric motors such cores may constitute both the stator and the rotor of the motor and substantially comprise a group of laminations overlapped on one another placed across the axis of rotation of the rotor.

The known processes for making such groups of laminations involve first the cutting of each lamination from a metal strip and then the overlapping of a desired number of them.

To fix the laminations together, the known technique employs indentations that guarantee the crimping of the laminations.

In the case where the group of laminations is intended to form the stator of an electric motor, during cutting the excess metal is removed along with the part of each lamination that intersects the cavity suited to house the rotor.

As known, this excess part of the lamination, which coincides with a part of the transverse perimeter of the cavity housing the rotor, defines a cross section of the polar expansions of the ferromagnetic core of the stator and its extension depends on the transverse dimensions of the rotor.

A first inconvenient aspect of the known processes employed for making said groups is represented by the fact that a considerable percentage of lamination is rejected. In fact the parts removed from each lamination to make the cavity for housing the rotor cannot be recovered and are the biggest production waste.

Another inconvenient aspect connected to the previous one is the fact that the scrap obtained during the described production process considerably influences the cost of each lamination and consequently of each group.

Another inconvenient aspect connected to the previous one is the fact that to such costs the costs for scrap disposal must be added.

An aim of this invention is to overcome said drawbacks.

In particular, a first aim of the invention is to propose a process that allows the manufacture of a group of laminations joined together automatically, without the intervention of operators and particularly suitable for being employed for making ferromagnetic cores.

Another aim of the invention is to propose a process that, compared to the known processes, allows the reduction of production waste.

A further aim of the invention is to propose a process that, compared to the known processes, allows a larger quantity of groups per time unit to be produced. Another aim of the invention is to make a group of laminations that is more economic compared to similar groups carried out with processes of the known type.

A further aim of the invention is to make a group that can be easily transported, without the risk that the laminations making it up will come apart.

Another aim of the invention is to propose a process that allows groups to be obtained that have substantially the same dimensional and qualitative characteristics which remain constant and repeated over time.

A further aim of the invention is to propose a process, a group of laminations and an electric machine that have a lower production cost compared to that of known groups.

Another aim of the invention is to propose a simple and reliable process.

Yet another aim of the invention is to offer an electric machine with a lower production cost compared to that of machines of the known type, and that is easy to produce and to assemble.

The purpose of the invention is fulfilled with the characteristics of the claims from 1 to 26.

Advantageous embodiments of the invention are described in the dependent claims.

The proposed solutions advantageously make it possible to manufacture a group of laminations joined together in a completely automatic way, and also ensure a notable reduction in the production costs.

Still advantageously, the proposed solutions allow scraps to be reduced to a minimum and make it possible to manufacture ferromagnetic cores even for electric machines and/or electric devices, considerably reducing their production costs.

Still advantageously, the proposed solutions allow the reduction of the cycle time necessary for making a group of laminations.

Said aims and advantages will be highlighted in greater detail in the description of some preferred embodiments of the invention, given purely as examples without limitation, with reference to the enclosed drawings, wherein:

FIG. 1 shows a section of a group of laminations carried out according to the invention;

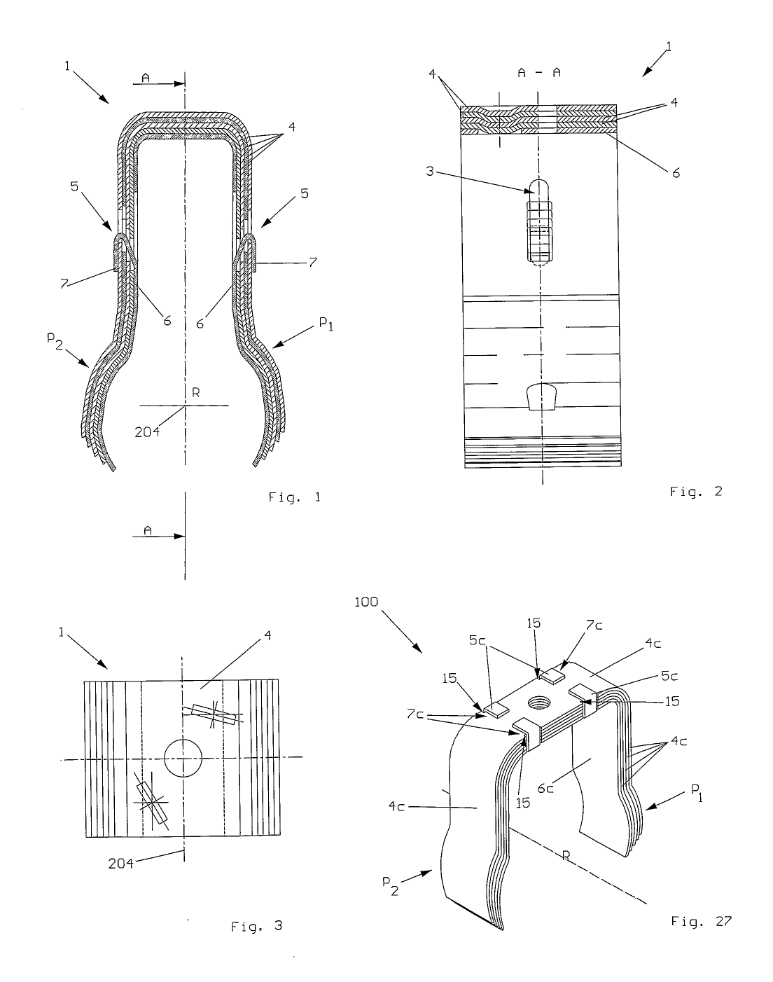

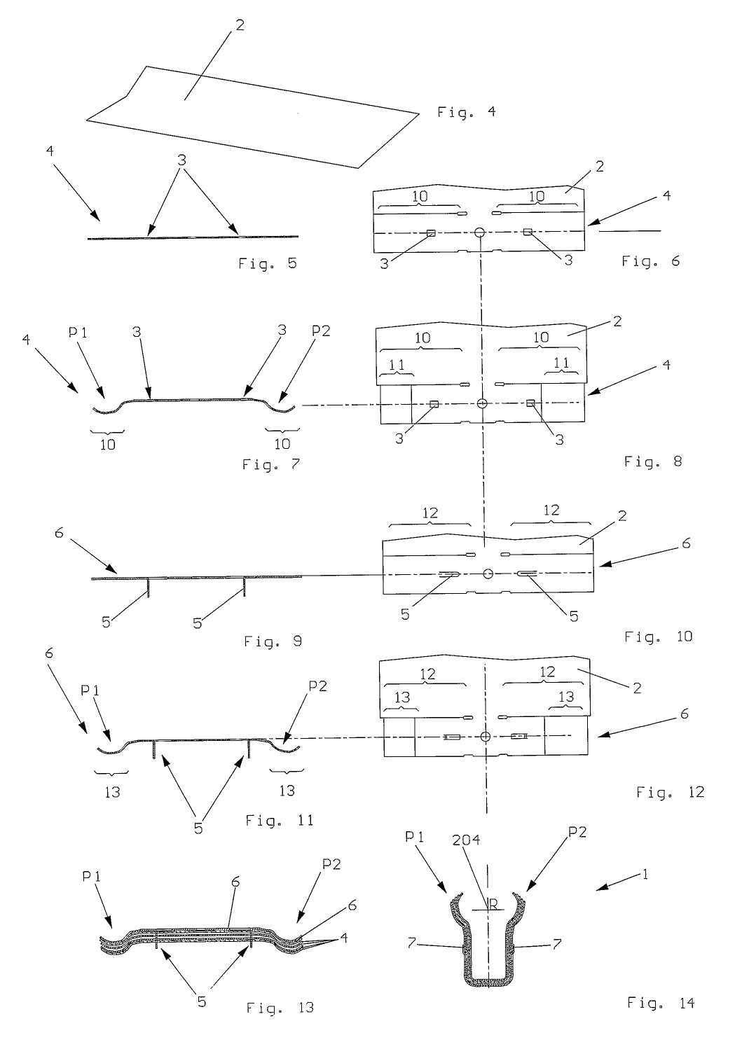

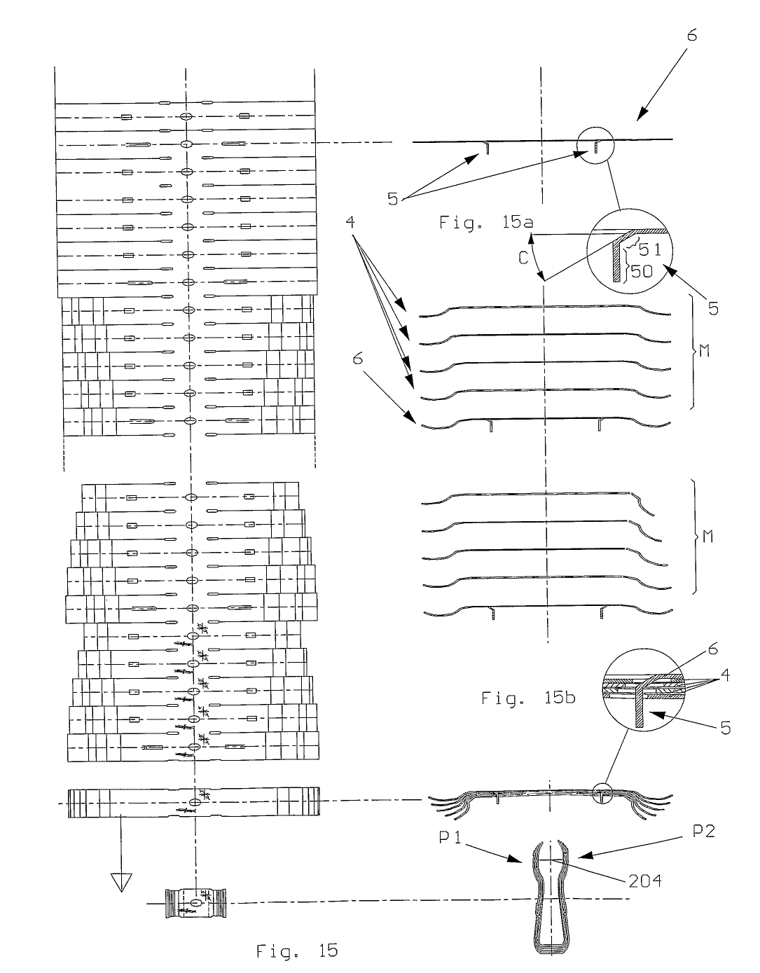

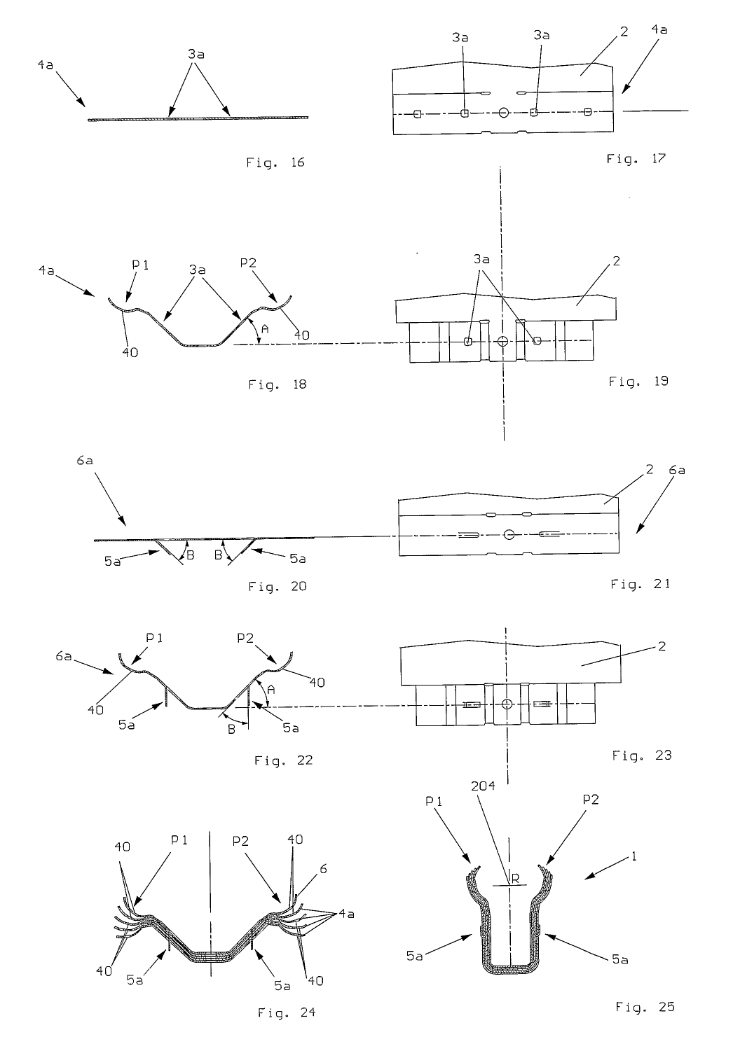

FIG. 2 shows a longitudinal section along plane A-A of the group of laminations shown in FIG. 1;

FIG. 3 shows a plan view of the group of laminations shown in FIG. 1;

Figures from 4 to 14 show a schematic view of the construction of the group of laminations in FIG. 1, carried out according to a process that is also subject of the invention;

FIG. 15 shows an example of application of the process subject of the invention;

FIGS. 15a and 15b show two enlarged section views of a part of some elements of the group of laminations of the invention, obtained with the process illustrated in FIG. 15;

Figures from 16 to 25 show a schematic view of the construction of the group of laminations shown in FIG. 1, carried out according to another process that is also subject of the invention;

FIG. 26 shows an example of application of another process that is also subject of the invention;

FIG. 27 shows an axonometric view of a further group of laminations subject of the invention;

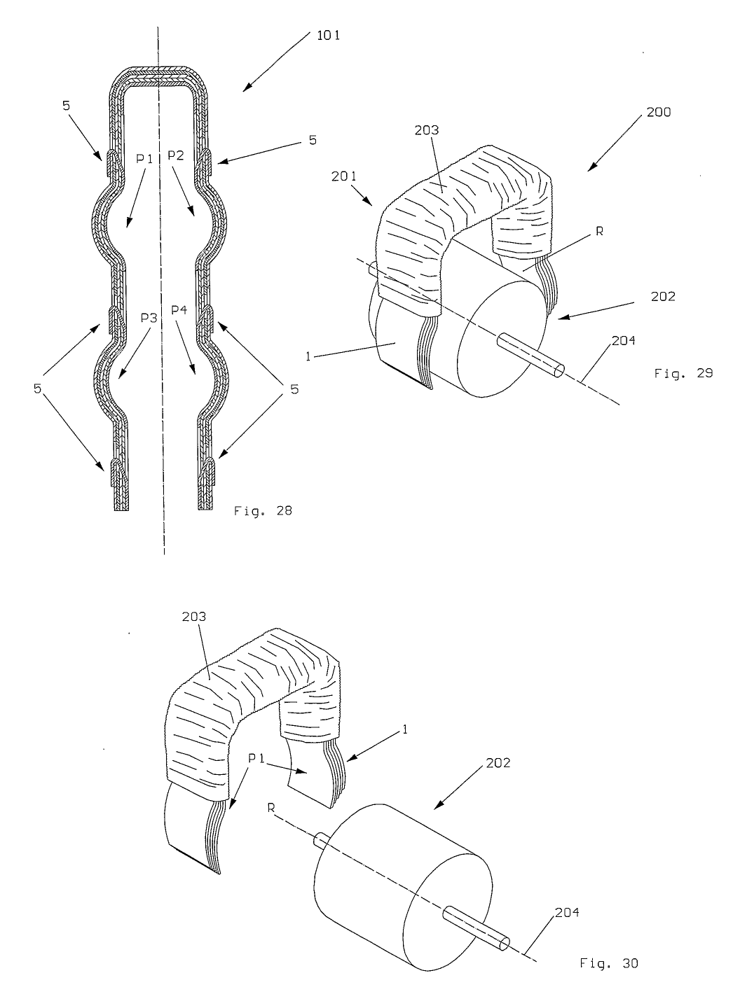

FIG. 28 shows a longitudinal section of another group of laminations subject of the invention;

FIG. 29 shows an axonometric view of an electric machine also subject of the invention;

FIG. 30 shows an exploded view of the machine shown in FIG. 29.

The embodiments of the invention described below refer to a process for making a group of laminations suited to form a ferromagnetic core used for the production of the stator of an electric machine, such as for example an electric motor.

It is clear that the proposed solution can also be applied for making any ferromagnetic core on any electric device.

According to the invention, a group of laminations subject of the present invention, indicated as a whole by number 1 in Figures from 1 to 3, comprises two or more laminations 4, 6, at least one of which 6 has at least one connecting element 5 having one end 7 that can be suitably folded for crimping and that acts against at least another one of said laminations to keep them together, each lamination being provided with a shaped part suited to form at least one polar expansion P1, P2 of a magnetic circuit.

Always according to the invention, the polar expansions P1 and P2 face each other and define a longitudinal axis 204 and a cavity R suited to house, for example and as will be better described below, the rotor of an electric machine.

Always according the invention, the laminations 4, 6 are placed and lie on planes that are substantially parallel to the longitudinal axis 204, thus advantageously ensuring a considerable reduction of scraps.

In a process for making a group of laminations 1 that is the subject of the invention, said group 1 is obtained from material in the form of a strip 2, shown in FIG. 4, with the following operations:
making one or more openings 3 in the strip 2 and cutting one or more parts of the strip 2, each corresponding substantially to at least one part 10 of the outline of a first lamination 4, as schematically shown in the cross section of the strip 2 in FIG. 5 and in the corresponding plan view in FIG. 6;
folding or bending, as schematically represented in the section and plan views of the strip 2 shown in FIGS. 7 and 8, respectively, at least one portion 11 of said at least one part 10 of the outline of said first lamination 4, said at least one portion 11 defining at least one polar expansion P1, P2 of the group 1;
separating said first lamination 4 from the strip 2;
   producing a desired number of first laminations 4 by cyclically repeating the operations described above, preferably on the same strip 2, and then:
cutting and folding one or more parts of the strip 2, each substantially corresponding to the outline of at least one connecting element 5, as schematically shown in the cross section in FIG. 9 and in the corresponding plan view of the strip 2 in FIG. 10;
cutting one or more parts of the strip 2, each substantially corresponding to at least one part 12 of the outline of a second lamination 6, as schematically represented in the section and plan views of the strip 2 shown in FIGS. 9 and 10, respectively;
folding or bending, as schematically represented in the section and plan views of the strip 2 shown in FIGS. 11 and 12, respectively, at least one portion 13 of said at least one part 12 of the second lamination 6, said at least one portion 13 defining at least one polar expansion P1, P2 of the group 1;
separating the second lamination 6 from the strip 2;
overlapping a desired number of first laminations 4, in the example shown four, and at least one second lamination 6, inserting each connecting element 5 in the corresponding opening 3, as shown in detail in FIG. 13;
folding substantially in a U shape the packet of laminations thus obtained, as shown in FIG. 14, so as to arrange the above-mentioned at least two polar expansions P1, P2 substantially facing each other and folding at least one portion of one end 7 of the connecting element 5 to block the laminations 4 and 6 and form the group 1, thus obtaining a crimped joint as shown in FIGS. 1 and 14.

In this particular case, the laminations of the first type 4 and the laminations of the second type 6 present substantially the same shape.

Advantageously, once the packet of laminations has been crimped in groups of two facing each other, as shown in FIGS. 1 and 14, the polar expansions P1, P2 define a longitudinal axis 204 and a seat R suited to advantageously house, for example, a rotor of an electric machine.

Each polar expansion P1, P2 substantially defines a portion of a surface of a cylindroid.

The presence of the connecting elements 5 advantageously allows the laminations 4, 6 to be kept joined together with no need to apply clamps or other components.

It must also be noted that, according to the example of application of the process subject of the invention, before the laminations are overlapped, the connecting element 5 is folded substantially at 90° with respect to the plane defined by the lamination 6, as shown in FIGS. 9 and 13. This advantageously allows the laminations 4 and 6 to be overlapped and perfectly aligned, as shown in FIG. 13.

It must also be noted that the openings 3 suited to receive the corresponding connecting element 5 present a width such as to compensate for the shifting of the same with respect to the axis of each element 5, as shown in FIGS. 1 and 14, after the laminations have been folded in a U shape.

The operations described above may also be advantageously performed using a progressive die provided with a suitable number of work stations to perform, even simultaneously, one or more of the operations described above.

FIG. 15 shows an example of a metal strip obtained with a progressive die comprising the work stations which perform the proposed process.

The implementation of the method represented in FIG. 15 ensures the complete automation of the production cycle to be obtained, with clear advantages in terms of both production costs and reduction of the time necessary to construct every single group 1.

It must also be noted that in the example shown in FIG. 15 the connecting element 5 comprises two parts 50 and 51, shown in the enlarged detail in FIG. 15a. The first part 50 is located substantially at 90° with respect to the plane defined by the lamination 2, while the second part is tilted at an angle C smaller than 90° with respect to the same plane.

This facilitates the overlapping of the laminations by assisting the movement, due to the shaped parts P1 and P2, that the laminations carry out on the plane defined by the lamination 2 during their overlapping, as shown in the enlarged detail in FIG. 15b.

In other embodiments both the angle C and the number of the parts into which the element 5 is divided may vary, depending for example on the number of laminations of which the group 1 is composed.

It must be noted that in this embodiment also the shaping/folding of each part 11, 13 of the respective laminations 4a and 6a, necessary to obtain the polar expansions P1, P2, is advantageously performed progressively with at least two successive operations or phases corresponding to as many stations indicated in FIG. 15 by M.

It must also be noted that the crimping of the laminations and their folding substantially in a U shape are carried out simultaneously and advantageously in the last station of the progressive die.

Another variant of the proposed process differs from the previous one due to the fact that, as shown in Figures from 16 to 25, at least one first folding of each lamination is carried out before overlapping the laminations 4a and 6a. This solution advantageously allows a better control of the folding angle of each lamination 4a and 6a to be obtained.

More precisely in this particular case, the folding of the laminations 4a, 6a substantially in a U shape is advantageously performed progressively with at least two successive operations or phases shown in FIGS. 18, 22 and 25.

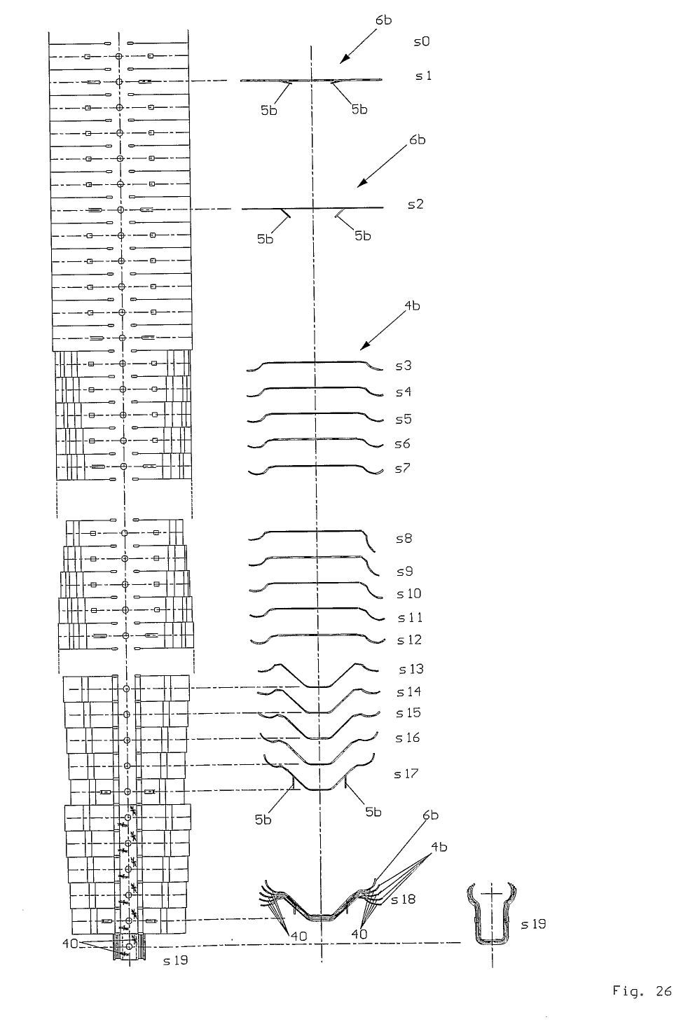

In particular, in the solution shown, the process contemplates that, before detaching the laminations 4a and 6a from the strip 2, a first fold is made with an angle A of a portion of the strip 2 which coincides with a part of the profile of each lamination 4a, 6a, as shown in FIGS. 18 and 22.

It must also be noted that in this embodiment the two connecting elements 5a are folded with an angle B of 90°−A.

This advantageously allows each connecting element 5a to be arranged substantially orthogonal to the plane defined by the strip 2 or by the short side of the U, thus allowing the overlapping and the alignment of the laminations 4a and 6a, as shown in FIG. 24.

The laminations, overlapping as explained above, are finally subjected to a further folding which positions the polar expansions P1, P2 facing each other as shown in FIG. 25. Each lamination therefore has a substantially U-shaped form with the polar expansions P1, P2 facing each other on the two sides and substantially orthogonal or transverse to the third side of the U.

In particular in the example shown the two facing sides define an angle of substantially 90° with respect to the short side, while in the embodiment shown in FIG. 15 the angle is smaller than 90°.

However, it is clear that in other embodiments this angle may vary.

It must also be noted that in this embodiment the openings 3a suited to receive the corresponding connecting element 5a present a width such as to compensate for the shifting of the same with respect to the axis of each element 5a, as shown in FIG. 24, after the overlapping of the laminations.

This guarantees the correct alignment of the various laminations as well as the possibility of further folding the laminations themselves.

FIG. 26 shows a metal strip obtained with a progressive die comprising the work stations which perform the process described above.

It must be noted that also in this embodiment also the shaping/folding of each part 11, 13 of the respective laminations 4b and 6b, necessary to obtain the polar expansions P1, P2, is advantageously performed progressively with at least two successive operations or phases corresponding to as many stations indicated in FIG. 26 by reference numbers from S3 to S12.

Likewise, the folding of the element 5B at the angle B is advantageously performed progressively with at least two successive operations or phases in the stations indicated in FIG. 26 by reference numbers S1 and S2.

This solution ensures better control during the performance of both the shaping of the polar expansions P1, P2 and the folding angle of the element 5b.

It must also be noted that the solutions proposed in FIG. 26 also contemplates, advantageously, the performance of the second folding of the laminations 4b and 6b, as well as the folding of the connecting elements 5b, substantially in a single moulding station of the progressive die, indicated in the Figure by S19.

However, it is clear that in other embodiments the folding of the laminations, as well as the folding of the connecting elements, may each be carried out in a different moulding station of the progressive die.

A further variant of the proposed process differs from the previous solutions due to the fact that, besides the operations described above, the process includes also an operation of indenting of the laminations close to one or more of the polar expansions P1, P2. This indenting, indicated by 40 in the FIGS. 18, 22, 24 and 26, advantageously allows the laminations to be held together and further aligned. This indenting in fact produces on each lamination a projection on one side and a cavity on the other side, said cavity being suited to receive the projection of the lamination with which it is in contact.

Another variant of the proposed process differs from the previous solutions due to the fact that the folding/shaping of each polar expansion P1, P2 and the U folding of each lamination are obtained in a single folding/moulding operation.

A further variant of the proposed process differs from the previous solutions due to the fact that it also involves the cutting of the ends of the laminations crimped together, carried out with a special punch which ensures the alignment of the ends of the laminations themselves, as shown in the example in FIG. 28 which will be described better here below.

Also the solutions described above may be advantageously implemented using a progressive die provided with a suitable number of work stations to perform one or more of the operations described above.

A further embodiment of a group of laminations subject of the invention, indicated as a whole by 100 in FIG. 27, differs from the previous ones due to the fact that the connecting element 5c laterally embraces the laminations 4c and 6c which form the group 100 itself.

In this case, according to the construction process employed, said group 100 is obtained from material in the form of a strip 2 with the following operations:
separating a first lamination 4c from the strip 2 before or after making the polar expansions P1, P2 obtained from a portion of the profile of the first lamination 4c itself in one or more of the ways previously described;
   producing a desired number of first laminations 4c, in this case four, by lo cyclically repeating the operation described above on the same strip 2, and then:
cutting one or more parts of the strip 2, each substantially corresponding to at least one part of the outline of a second lamination 6c which includes the outline of at least one connecting element 5c;
folding or bending at least one or more parts of said second lamination 6c in correspondence with said one or more parts of the second lamination 6c suited to define a corresponding polar expansion P1, P2;
separating a second lamination 6c from the strip 2;
overlapping a desired number of first laminations 4c, in the example shown four, and the second lamination 6c, said at least one connecting element 5c being positioned across the plane defined by each lamination 4c, 6c and facing the perimeter of each lamination;
folding the packet of laminations so as to arrange the polar expansions P1, P2 substantially facing each other;
folding at least one portion of one end 7c of the connecting element 5c to block the laminations 4c and 6c and form the group 100, obtaining a crimped joint.

In this case too, before overlapping the laminations the folding of at least one part of at least one connecting element 5c may be carried out, so that, during said overlapping operation, said connecting element is positioned facing the perimeter of each one of said first laminations.

In this case, too, the polar expansions P1, P2, the connecting element 5c and the laminations 4c and 6c may be subjected to the progressive folding operations described above.

It must also be noted that in this embodiment the first laminations 4c present, at the level of each connecting element 5c, a seat or groove 15 on the perimeter, suited to receive the element 5c, which allows the reduction of the bulk of the element 5c itself.

In the examples of application of the processes described, the connecting elements all belong to the same lamination. It is clear that in other solutions these elements may also belong to several different laminations and they may be present in any number.

It is also clear that according to the proposed process the lamination with the connecting elements may be located either first or last in the overlapping operation. In the first case one or more of said first laminations is/are overlapped lo on the second lamination, inserting at least one connecting element in the openings or in the seats, obtaining alignment and forming the packet of laminations. In the other case the alignment of the first laminations is guaranteed by the seat suited to receive the laminations themselves, defined in the moulding station where they are overlapped and subsequently crimped.

It is clear that all the operations described above may be carried out in a different order and that more than one of them may be performed in the same phase.

It is clear that the number of polar expansions may vary according to the need. For example, FIG. 28 shows a group of laminations, indicated as a whole by 101, comprising 4 polar expansions P1, P2, P3 P4 facing each other two by two, carried out with the proposed process.

Lastly, FIGS. 29 and 30 show an electric machine 200, also subject of the invention, comprising a stator 201 with a ferromagnetic core composed of a group of laminations 1 of the type previously described and a rotor 202.

As previously explained, the group of laminations 1 defines a longitudinal axis 204 and a cavity R suited to house a rotor 202 positioned with the axis of rotation parallel to and substantially coinciding with the longitudinal axis 204.

A winding 203 is wound on the ferromagnetic core, and said winding, in the case of an electric motor, is suitably fed to generate a magnetic field which is conveyed towards the polar expansions P1, P2 to interact with the rotor 202, while, in the case of a dynamo, it forms the winding on which an electromotive force is induced.

The above description clearly shows that the proposed solution allows the said drawbacks to be overcome.

In particular, the proposed solution allows the complete automation of the production cycle to be obtained, with clear advantages in terms of both production costs and reduction of the time necessary to construct every single group 1.

Again advantageously, the proposed solution allows the reduction of the production costs by guaranteeing the repeatability over time of the characteristics both of each lamination and of the group of laminations obtained.

Again advantageously, with the proposed solutions a mean reduction of about 300% in the gross weight of each group 1, 100 has been observed. In fact, in the proposed solution the scrap material derives only from the perforation necessary for the tool that centers the strip in the progressive die and from the openings 3, lo while, in the groups of laminations made with the known processes, the scrap material involves the whole area of the lamination which covers the cross section of the cavity suited to house, for example, a rotor.

Again advantageously, the proposed process allows the reduction of the processing costs; in fact, with the same geometric characteristics of the ferromagnetic core and more precisely with the same thickness, it is possible to reduce the number of laminations.

This also allows, advantageously, the reduction of the number of blows that the die must strike to make a group having the same characteristics. As an example, it is pointed out that to make a 25 mm thick and 4.5 mm width group of laminations, using laminations being each 0.65 mm thick, the known technique requires a total of thirty-eight laminations whereas, with the process subject of the invention, the same group may be obtained with only five laminations 25 mm high and 0.9 mm thick. From all that has been said it is also clear how the die which performs the traditional process must be operated thirty-eight times, while the die carried out according to the invention is operated only five times. This advantageously ensures, for the die carried out according to the invention, a mean life about seven times longer than the mean life of a die of the traditional type.

Again advantageously, the proposed solution allows the reduction of the cycle time necessary to make each group of laminations and does not need the intervention of operators.

Advantageously, the proposed solution allows the construction of electric devices and/or their parts, as well as stators for electric motors having the laminations which lie on one or more planes parallel to the axis of rotation of said motor, considerably reducing their production cost.

Although the invention has been described with reference to the enclosed drawings, upon implementation modifications may be made, all falling within the inventive concept expressed by the claims listed below and therefore protected by the present patent.

1) A process for making a group of laminations (100), advantageously but not exclusively for making a ferromagnetic core, comprising two or more laminations, characterised in that said group is obtained from material in the form of a strip (2) with the following operations:
cutting one or more parts of said strip (2), each corresponding substantially to at least one part of the outline of a first lamination (4c);
folding or bending at least one portion of said at least one part of the outline of said first lamination (4c), said at least one portion defining at least one polar expansion (P1, P2) of said group (1);
separating said first lamination (4c) from said strip (2); repeating said operations to make a desired number of said first laminations (4c);
cutting one or more parts of said strip (2), each substantially corresponding to at least one part of the outline of a second lamination (6c) which includes the outline of at least one connecting element (5c);
folding or bending at least one portion of said at least one part of said second lamination (6c), said at least one portion defining at least one polar expansion (P1, P2) of said group (100);
separating said second lamination (6c) from said strip (2);
overlapping one or more of said first laminations (4c) and said second lamination (6c) to form a packet of laminations;
folding said packet of laminations so as to arrange said polar expansions (P1, P2) substantially facing each other;
folding at least one portion of one end (7c) of said at least one connecting element (5c) to block said laminations (4c and 6c).

2) A process according to claim 1, characterised in that before overlapping said laminations the following operation is carried out:
folding at least one part of said at least one connecting element (5c) so that, during said overlapping operation, said connecting element is positioned facing the perimeter of each one of said first laminations.

3) A process according to claim 1, characterised in that during the cutting of said first laminations a seat (15) is made on the perimeter, said seat being suited to house said at least one connecting element (5c).

4) A process for making a group of laminations (1, 101), advantageously but not exclusively for making a ferromagnetic core, comprising two or more laminations (4, 4a, 4b, 6, 6a, 6b), characterised in that said group (1, 101) is obtained from material in the form of a strip (2) with the following operations:
making one or more openings (3) in said strip (2);
cutting one or more parts of said strip (2), each corresponding substantially to at least one part (10) of the outline of a first lamination (4, 4a, 4b);
folding or bending at least one portion (11) of said at least one part (10) of the outline of said first lamination (4, 4a, 4b), said at least one portion (11) defining at least one polar expansion (P 1, P2) of said group (1);
separating said first lamination (4, 4a, 4b) from said strip (2); repeating said operations to make a desired number of said first laminations (4, 4a, 4b);
cutting and folding one or more parts of said strip (2), each substantially corresponding to the outline of at least one connecting element (5, 5a, 5b);
cutting one or more parts of said strip (2), each substantially corresponding to at least one part (12) of the outline of a second lamination (6, 6a, 6b);
folding or bending at least one portion (13) of said at least one part of said second lamination (6, 6a, 6b), said at least one portion (11) defining at least one polar expansion (P1, P2, P3, P4) of the group (1);
separating said second lamination (6, 6a, 6b) from said strip (2);
overlapping on said second lamination (6, 6a, 6b) one or more of said first laminations (4, 4a, 4b), inserting said at least one connecting element (5, 5a, 5b) in one of said one or more openings (3), forming a packet of laminations;
folding said packet of laminations so as to arrange said polar expansions (P1, P2, P3, P4) substantially facing each other;
folding at least one portion of one end (7) of said at least one connecting element (5, 5a, 5b) to block said laminations (4, 4a, 4b, 6, 6a, 6b).

5) A process for making a group of laminations (1, 101), advantageously but not exclusively for making a ferromagnetic core, comprising two or more laminations, characterised in that said group (1, 101) is obtained from material in the form of a strip (2) with the following operations:
making one or more openings (3) in said strip (2);
cutting one or more parts of said strip (2), each corresponding substantially to at least one part (10) of the outline of a first lamination (4, 4a, 4b);
folding or bending at least one portion (11) of said at least one part (10) of the outline of said first lamination (4, 4a, 4b), said at least one portion (11) defining at least one polar expansion (P1, P2, P3, P4) of said group (1, 101);
separating said first lamination (4, 4a, 4b) from said strip (2); repeating said operations to make a desired number of said first laminations (4, 4a, 4b);
cutting and folding one or more parts of said strip (2), each substantially corresponding to the outline of at least one connecting element (5, 5a, 5b);
cutting one or more parts of said strip (2), each substantially corresponding to at least one part (12) of the outline of a second lamination (6, 6a, 6b);
folding or bending at least one portion (13) of said at least one part of said second lamination (6, 6a, 6b), said at least one portion (11) defining at least one polar expansion (P1, P2, P3, P4) of the group (1, 101);
separating said second lamination (6, 6a, 6b) from said strip (2);
overlapping one or more of said first laminations (4, 4a, 4b) aligning said one or more openings (3) and overlapping said second lamination (6, 6a, 6b), inserting said at least one connecting element (5, 5a, 5b) in one of said one or more openings (3), forming a packet of laminations;
folding said packet of laminations so as to arrange said polar expansions (P 1, P2, P3, P4) substantially facing each other;
folding at least one portion of one end (7) of said at least one connecting element (5, 5a, 5b) to block said laminations (4, 4a, 4b, 6, 6a, 6b).

6) A process according to claim 1, characterised in that said operation of folding said packet of laminations so as to arrange said polar expansions (P1, P2, P3, P4) substantially facing each other and said operation of folding at least one portion of one end (7) of said at least one connecting element (5, 5a, 5b) are carried out simultaneously.

7) A process according to claim 1, characterised in that said packet of laminations is folded so as to present a substantially U-shaped form with the polar expansions (P1, P2, P3, P4) made on the two facing sides.

8) A process according to claim 1, characterised in that said folding or bending of said at least one portion (13) of said at least one part of said first lamination (4) or of said second lamination (6), defining said at least one polar expansion (P1, P2), is obtained progressively with at least two operations.

9) A process according to claim 1, characterised in that said folding of said laminations suited to arrange said polar expansions (P1, P2) substantially facing each other is obtained progressively with at least two operations.

10) A process according to claim 1, characterised in that before separating said at least one first lamination from said strip the following operation is performed:
first folding of said one part of said at least one first lamination (4, 4a, 4b, 4c) at an angle smaller than 90°; and in that before separating said second lamination from said strip the following operation is performed:
first folding of said one part of said second lamination (6, 6a, 6b) at an angle smaller than 90°.

11) A process according to claim 10, characterised in that said first folding of said part of said second lamination (6, 6a, 6b) defines an angle A and in that said at least one connecting element defines an angle B such as to allow the overlapping of said laminations.

12) A process according to claim 11, characterised in that said angle B is substantially equal to 90°−A.

13) A process according to claim 1, characterised in that said folding of said at least one connecting element is obtained progressively with at least two operations.

14) A process according to claim 1, characterised in that said at least one connecting element (5) comprises at least two parts (50, 51), at least one of said parts defining an angle (C) smaller than 90° with respect to the plane defined by said lamination (6).

15) A process according to claim 1, characterised in that it also comprises an operation of indenting said laminations, useful to align and/or hold said laminations.

16) A process according to claim 1, characterised in that
some of said operations of cutting and/or folding and/or bending of said laminations are performed simultaneously.

17) A process according to claim 1, characterised in that said operations are performed with a progressive die.

18) A progressive die, characterised in that it comprises two or more stations suited to perform the operations according to claim 1.

19) A die according to claim 18, characterised in that it comprises at least one moulding station in which said laminations are overlapped, folded in order to arrange said polar expansions substantially facing each other, and in which said at least one portion of said at least one connecting element is folded.

20) A group of laminations (1, 100, 101), advantageously but not exclusively for making a ferromagnetic core, comprising two or more laminations, characterised in that it is made according to the process of claim 1.

21) A group of laminations (1, 100, 101), advantageously but not exclusively for making a ferromagnetic core, comprising two or more laminations, characterised in that it comprises one or more polar expansions (P1, P2, P3, P4) and a connecting element (5, 5a, 5b, 5c) belonging to one of said laminations (4, 4a, 4b, 4c, 6, 6a, 6b, 6c), said at least one connecting element presenting at least one end (7, 7c) suitably folded and counteracting at least another of said laminations to keep said laminations joined together.

22) A group according to claim 21, characterised in that said laminations are made by cutting a metal strip.

23) A group according to claim 21, characterised in that said at least one connecting element is inserted in an opening (3, 3a) made in at least some of said laminations.

24) A group according to claim 21, characterised in that said polar expansions (P1, P2) face each other and define a longitudinal axis (204) and a cavity (R) suited to house, advantageously but not exclusively, a rotor (202) of an electric machine, said laminations lying on planes substantially parallel to said longitudinal axis (204).

25) An electric machine (200) comprising a stator (201) and a rotor (202), characterised in that said stator comprises at least one ferromagnetic core having at least one group of laminations carried out according to the contents of claim 1.

26) A machine according to claim 25, characterised in that said laminations of said stator lie on one or more planes parallel to the axis of rotation (204) of said rotor.
